(19) United States
(12) Patent Application Publication
(10) Pub. No.: US 2001/0056477 A1
(43) Pub. Date: Dec. 27, 2001

(54) Method and system for distributing captured motion data over a network

(76) Inventors: Brennan J. McTernan, Fanwood, NJ (US); Steven Giangrasso, Valley Stream, NY (US)

Correspondence Address: Brown Raysman Millstein Felder & Steiner, LLP, 900 Third Avenue, New York, NY, 10022-4728, US

(21) Appl. No.: 09/784,530

(22) Filed: Feb. 15, 2001

Related U.S. Application Data
(60) Provisional application No. 60/182,434, filed on Feb. 15, 2000.

(51) Int. Cl. G06F 17/00; G06F 15/16

(52) U.S. Cl. 709/219; 345/418; 345/158; 345/10

(57) ABSTRACT

A system and method is presented for distributing motion data over a network to a client device. The method involves storing a data model representing an actor, which may be a human actor or any other living or inanimate object. The motion of an actor at a first time and a second time is also recorded. The separate model and motion data items are transferred from a server to a client, thereby enabling the client device to reproduce the actor's motion as captured. The method is implemented by a system comprising a positional data capturing system for capturing motion data representing a position and attitude of an actor at a first time and a second time, a model storage system for storing models of the actors, the models comprising the skeletal geometry and texture of the actor, and a transmission system for transmitting the model in association with corresponding motion data for presentation by one or more clients.

Applicant(s) hereby claims the benefit of provisional patent application Ser. No. 60/182,434, titled “MOTION CAPTURE ACROSS THE INTERNET,” filed Feb. 15, 2000, attorney docket no. 38903-010. The application is incorporated by reference herein in its entirety.

### RELATED APPLICATIONS

This application is related to the following commonly owned patent applications, each of which applications is hereby incorporated by reference herein in its entirety:

application Ser. No. 09/767,268, titled “SYSTEM AND METHOD FOR ACCOUNTING FOR VARIATIONS IN CLIENT CAPABILITIES IN THE DISTRIBUTION OF A MEDIA PRESENTATION,” attorney docket no. 4700/4;

application Ser. No. 09/767,603, titled “SYSTEM AND METHOD FOR USING BENCHMARKING TO ACCOUNT FOR VARIATIONS IN CLIENT CAPABILITIES IN THE DISTRIBUTION OF A MEDIA PRESENTATION,” attorney docket no. 4700/5; 4700/8

application Ser. No. 09/767,602, titled “SYSTEM AND METHOD FOR MANAGING CONNECTIONS TO SERVERS DELIVERING MULTIMEDIA CONTENT,” attorney docket no. 4700/6; and

application Ser. No. 09/767,604, titled “SYSTEM AND METHOD FOR RECEIVING PACKET DATA MULTICAST IN SEQUENTIAL LOOPING FASHION,” attorney docket no. 4700/7.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to techniques for delivering captured motion data across networks. More particularly, the present invention relates to an improved system and method for capturing motion data and distributing it from a server to one or more clients while minimizing the amount of bandwidth required for the distribution.

Over the past decade, processing power available to both producers and consumers of multimedia content has increased exponentially. Approximately a decade ago, the transient and persistent memory available to personal computers was measured in kilobytes (8 bits=1 byte, 1024 bytes=1 kilobyte) and processing speed was typically in the range of 2 to 16 megahertz. Due to the high cost of personal computers, many institutions opted to utilize “dumb” terminals, which lack all but the most rudimentary processing power, connected to large and prohibitively expensive mainframe computers that “simultaneously” distributed the use of their processing cycles with multiple clients.

Today, transient and persistent memory is typically measured in megabytes and gigabytes, respectively (1,048,576 bytes=1 megabyte, 1,073,741,824 bytes=1 gigabyte).

Processor speeds have similarly increased, with modern processors based on the x86 instruction set available at speeds up to 1.5 gigahertz (approximately 1000 megahertz=1 gigahertz). Indeed, processing and storage capacity have increased to the point where personal computers, configured with minimal hardware and software modifications, fulfill roles such as data warehousing, serving, and transformation, tasks that in the past were typically reserved for mainframe computers. Perhaps most importantly, as the power of personal computers has increased, the average cost of ownership has fallen dramatically, providing significant computing power to average consumers.

The past decade has also seen the widespread proliferation of computer networks. With the development of the Internet in the late 1960's followed by a series of inventions in the fields of networking hardware and software, the foundation was set for the rise of networked and distributed computing. Once personal computing power advanced to the point where relatively high speed data communication became available from the desktop, a domino effect was set in motion whereby consumers demanded increased network services, which in turn spurred the need for more powerful personal computing devices. This also stimulated the industry for Internet Service providers or ISPs, which provide network services to consumers.

Computer networks transfer data according to a variety of protocols, such as UDP (User Datagram Protocol) and TCP (Transport Control Protocol). According to the UDP protocol, the sending computer collects data into an array of memory referred to as a packet. IP address and port information is added to the head of the packet. The address is a numeric identifier that uniquely identifies a computer that is the intended recipient of the packet. A port is a numeric identifier that uniquely identifies a communications connection on the recipient device. According to the Transmission Control Protocol, or TCP, data is sent using UDP packets, but there is an underlying “handshake” between sender and recipient that ensures a suitable communications connection is available. Furthermore, additional data is added to each packet identifying its order in an overall transmission. After each packet is received, the receiving device transmits acknowledgment of the receipt to the sending device. This allows the sender to verify that each byte of data sent has been received, in the order it was sent, to the receiving device. Both the UDP and TCP protocols have their uses. For most purposes, the use of one protocol over the other is determined by the temporal nature of the data.

Data can be viewed as being divided into two types, transient or persistent, based on the amount of time that the data is useful. Transient data is data that is useful for relatively short periods of time. For example, a television video signal consists of 30 frames of imagery each second. Thus, each frame is useful for 1/30th of a second. For most applications, the loss of one frame would not diminish the utility of the overall stream of images. Persistent data, by contrast, is useful for much longer periods of time and must typically be transmitted completely and without errors. For example, a downloaded record of a bank transaction is a permanent change in the status of the account and is necessary to compute the overall account balance. Loosing a bank transaction or receiving a record of a transaction containing errors would have harmful side effects, such as inaccurately calculating the total balance of the account.

UDP is useful for the transmission of transient data, where the sender does not need to be delayed verifying the receipt of each packet of data. In the above example, a television broadcaster would incur an enormous amount of overhead if it were required to verify that each frame of video transmitted has been successfully received by each of the millions of televisions tuned into the signal. Indeed, it is inconsequential to the individual television viewer that one or even a handful of frames have been dropped out of an entire transmission. TCP, conversely, is useful for the transmission of persistent data where the failure to receive every packet transmitted is of great consequence.

Thus, there have been drastic improvements in the computer technology available to consumers of content and in the delivery systems for distributing such content. Such improvements, however, have not been properly leveraged to improve the quality and speed of video distribution. There is thus a need for a system and method that distributes responsibilities for video distribution and presentation among various components in a computer network to more effectively and efficiently leverage the capabilities of each part of the network and improve overall performance.

### BRIEF SUMMARY OF THE INVENTION

It is an object of the present invention to solve the problems described above associated with the distribution of motion data over computer networks.

It is another object of the present invention to reduce the amount of bandwidth required to deliver motion data across a computer network.

The above and other objects are achieved by distributing the effort required to display motion on a client device between a server and client. The server sends the client two general types of data—a three-dimensional model of an actor or object and motion data representing the position and attitude of the actor or object over a period of time. The model data represents the static elements of the presentation, such as texture, color, and skeletal geometry, while the motion data represents changes to the object over a period of time, such as a person talking, running, dancing, or undergoing any other type of motion. The model data may be comprised of a wireframe based on the captured dimensions of an actor with a texture map of the human actor or object applied to the model. Alternatively, the model may be generated entirely using 3D modeling software as known to those skilled in the art. The motion data allows for the proper manipulation of the model consistent with the motion of the object being recorded or observed.

Advantageously, the server may send one or more models well in advance of any given motion data, and the client can store the models in persistent memory and can reuse them with later received motion data. This reduces the bandwidth required during transmission of the motion data. Additional identification data may be transmitted with a stream of motion data to associate it with a previously transmitted model.

Actors or objects are manipulated while being tracked by a positional data generator. The positional data generator gathers raw data regarding the location of a marker or markers in 2D space. By tracking the marker from multiple locations, the position of the marker in 3D space is triangulated. Tracking systems contemplated by the system include, but are not limited to, infrared tracking systems and electromagnetic tracking systems. The positional data from multiple markers is combined to determine the motion of an object, which is used to manipulate the model and recreate the motion of the captured object on the client.

Some of the above and other objects of the present invention are achieved by a method for distributing motion data over a network for display on a client device. The method includes storing model data representing an actor or object that is to be manipulated in a video presentation, capturing motion data representing the motion and orientation of the actor or object during the action in the video, and transmitting from a server to the client device as separate data items the model data and motion data to thereby enable the client to produce and display a video of the actor or object being manipulated over a period of time, e.g., dancing or running.

Objects of the invention are also achieved through a system for preparing motion data for distribution over a network to one or more clients, the motion data containing the motion of one or more actors. The system contains both positional data generator and calculator systems for capturing position data representing the motion, location and attitude of an actor or object in three dimensions over a period of time, and a transmission system for transmitting model data in association with corresponding motion data for presentation by one or more clients.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a system implementing one embodiment of the present invention;

FIG. 2 is a series of illustrations presenting wireframe models with and without texture maps in accordance with one embodiment of the present invention;

FIG. 3 is a diagram illustrating triangulation of marker positions in accordance with one embodiment of the present invention;

FIG. 4 is an illustration presenting a human actor outfitted with an electromagnetic motion capture system in accordance with one embodiment of the present invention;

FIG. 5 is a flow chart showing a process of generating and distributing model and motion data in the system of FIG. 1 in accordance with one embodiment of the present invention;

FIG. 6 is a flow diagram showing a process of capturing motion data through the use of infrared reflective markers in accordance with one embodiment of the present invention; and

FIG. 7 is a flow diagram showing a process of capturing motion data through the use of electromagnetic sensors in accordance with one embodiment of the present invention.

### DETAILED DESCRIPTION OF THE PREFERRED EMBODIMENTS

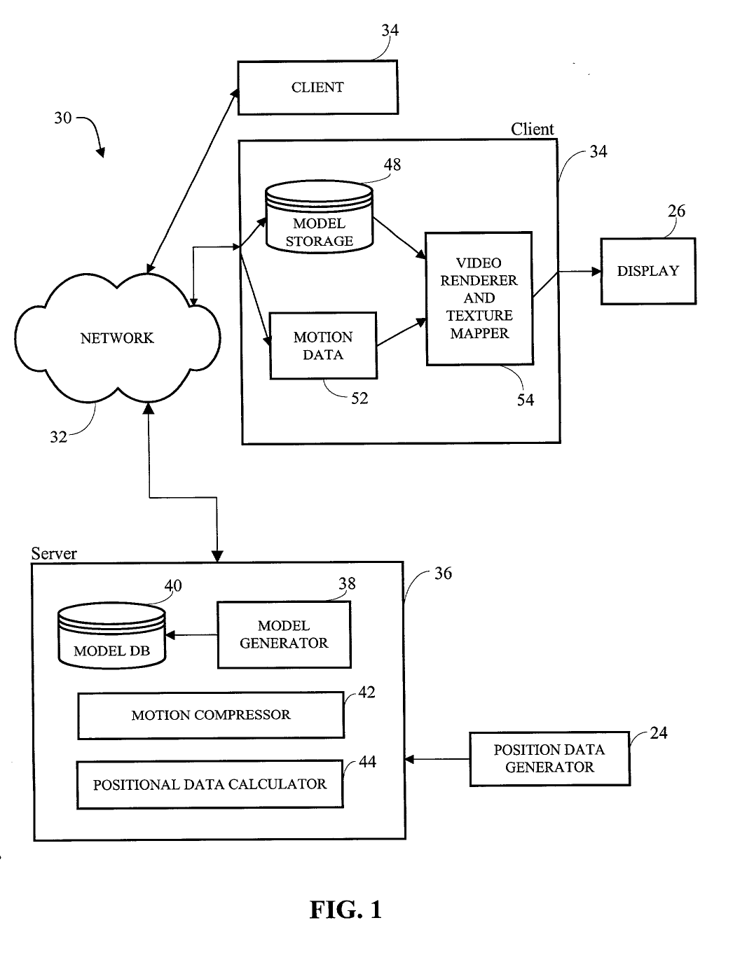

Embodiments of the present invention are now described with reference to the drawings in FIGS. 1-5. Referring to FIG. 1, a system 30 of one preferred embodiment of the invention is implemented in a computer network environment 32 such as the Internet, an intranet or other closed or organizational network. A number of clients 34 and servers 36 are connectable to the network 32 by various means, including those discussed above. For example, if the network 32 is the Internet, the servers 36 may be web servers which receive requests for data from clients 34 via HTTP, retrieve the requested data, and deliver them to the client 34 over the network 32. The transfer may be through TCP or UDP, and data transmitted from the server may be unicast to requesting clients or available for multicasting to multiple clients at once through a multicast router.

In accordance with the invention, the server 36 contains several components or systems including a model generator 38, a model database 40, a motion compressor 42, and a positional data calculator 44. These components may be comprised of hardware and software elements, or may be implemented as software programs residing and executing on a general purpose computer and which cause the computer to perform the functions described in greater detail below.

Producers of multimedia content use the model generator 38 to develop a three-dimensional model of an actor or object. As used herein, the term actor is intended to include any object such as a person, animal or inanimate object, which is moving or otherwise changing. The model may be based on recorded images of an actual actor or may be generated completely based upon computer generated graphical objects. In some embodiments, the model generator includes a 3D renderer. 3D Rendering is a process known to those of skill in the art of taking mathematical representations of a 3D world and creating 2D imagery from these representations.

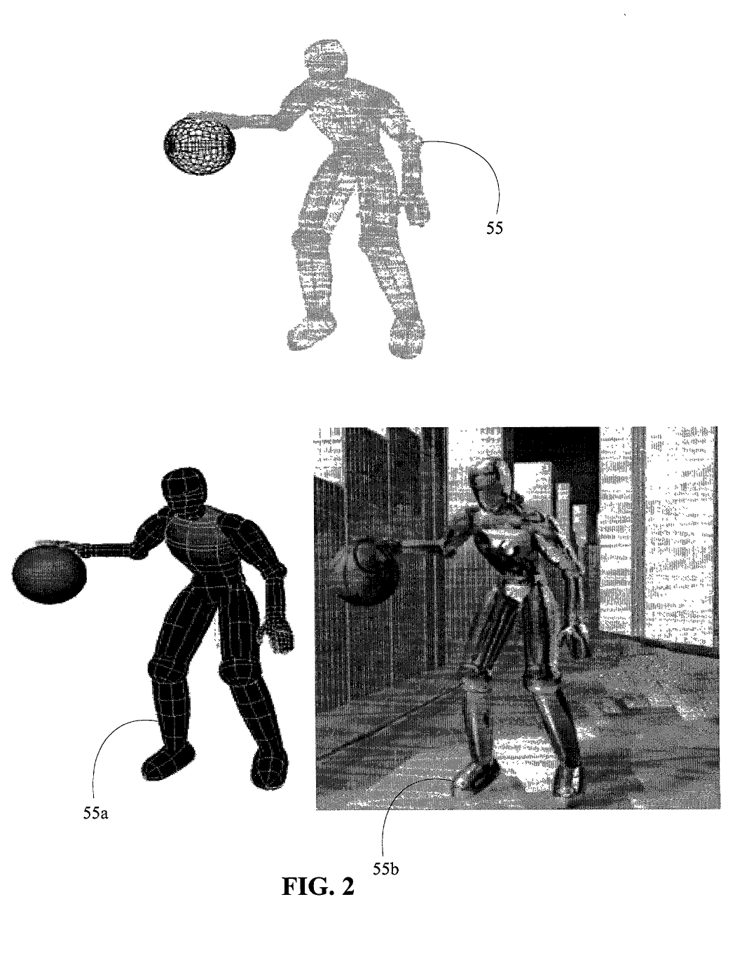

This mapping from 3D to 2D is done in an analogous way to the operation of a camera. FIG. 2 presents an exemplary 3D wireframe model 55 generated by a 3D renderer, a 3D wireframe model with an opaque texture map applied to it 55a, and a 3D wireframe model with a reflective texture map 55b placed within a virtual set. An exemplary virtual set is disclosed in commonly owned patent application Ser. No. 09/767,672, titled “METHOD AND SYSTEM FOR DISTRIBUTING VIDEO USING A VIRTUAL SET”, filed on Jan. 22, 2001, attorney docket number 4700/2, now pending, which is incorporated herein by reference in its entirety.

The 3D renderer maintains data about the objects of a 3D world in 3D space, and also maintains the position of a camera in this 3D space. In the 3D renderer, the process of mapping the 3D world onto a 2D image is achieved using matrix mathematics, numerical transforms that determine where on a 2D plane a point in 3D space would project. Meshes of triangles in 3D space represent the surface of objects in the 3D world. Using the matrices, each vertex of each triangle is mapped onto the 2D plane. Triangles that do not fall onto the visible part of this plane are ignored and triangles that fall partially onto this plane are cropped.

The 3D renderer determines the colors for the 2D image using a shader that determines how the pixels for each triangle fall onto the image. The shader does this by referencing a material that is assigned by the producer of the 3D world. The material is a set of parameters that govern how pixels in a polygon are rendered, such as properties about how this triangle should be colored. Some objects may have simple flat colors, others may reflect elements in the environment, and still others may have complex imagery on them. Rendering complex imagery is referred to as texture mapping, in which a material is defined with two traits—one trait being a texture map image and the other a formula that provides a mapping from that image onto an object. When a triangle using a texture mapped material is rendered, the color of each pixel in each triangle is determined by the formulaically mapped pixel in the texture map image.

Models generated by the model generator 38 are stored in the model database 40 on the server 36, so they may be accessed and downloaded by clients 34. Models of actors or objects may be considered persistent data, to the extent they do not change over time but rather remain the same from frame to frame during the display of motion data. As a result, models of actors or objects are preferably downloaded from the server 36 to clients 34 in advance of the transmission of given motion data. This reduces the bandwidth load required during transmission of a given video.

The motion compressor 42 receives motion data from the positional data calculator 44 for compression prior to transmission. The motion compressor 42 reduces the size of the motion data representing the location and orientation of the actor or object through the use of mathematical algorithms that encode the data. The encoding process allows the size of the digital position data to be reduced, thus reducing the bandwidth required for transmission of the presentation.

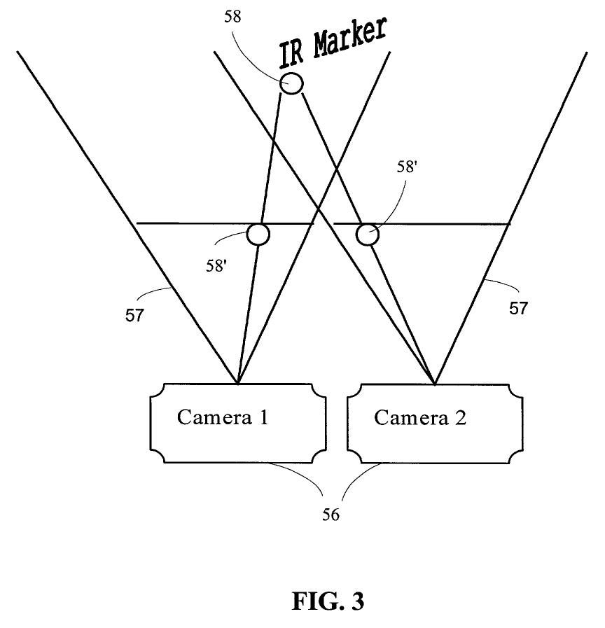

A position data generator 24 is used to capture raw positional data. According to one embodiment of the invention, a system of infrared reflective markers and cameras are used to capture the motion and attitude of an actor. Infrared sensitive cameras are positioned at known stationary points in the set to detect markers worn by or placed on the actors. The position of these markers in 3D space is detected by triangulation. FIG. 3 is a top down view of two 2D cameras 56 taking the position of an infrared reflective marker 58. Both cameras 56 have unique views represented by the straight lines 57. These lines 57 indicate the plane on which the real world is projected in the camera 56. Both cameras are at known positions. The circles 58′ on the field of view represent the different points at which the infrared reflective marker 58 appears on the cameras 56. These points are recorded and used to triangulate the position of the marker 58 in 3D space, as known to those of skill in the art.

According to alternative embodiments, the position data generator consists of a system of coils and sensors to generate raw positional data. Electromagnetic motion capture employs the pulsed generation of a magnetic field. This field is generated through the use of a plurality of large coils oriented along orthogonal axes. A magnetic field is cycled on and off at high speed. A sensor worn by the actor is comprised of three orthogonally oriented coils, which measure the strength of the field generated along each axis. When the field is off, these sensors measure the magnetic field of the earth. By comparing the vector of the earth's magnetic field and the vector of the source of the artificial magnetic field, the positional data calculator 44 triangulates the location and orientation of the sensor. The location and orientation of these sensors is used to determine the location and orientation of the object to which they are attached.

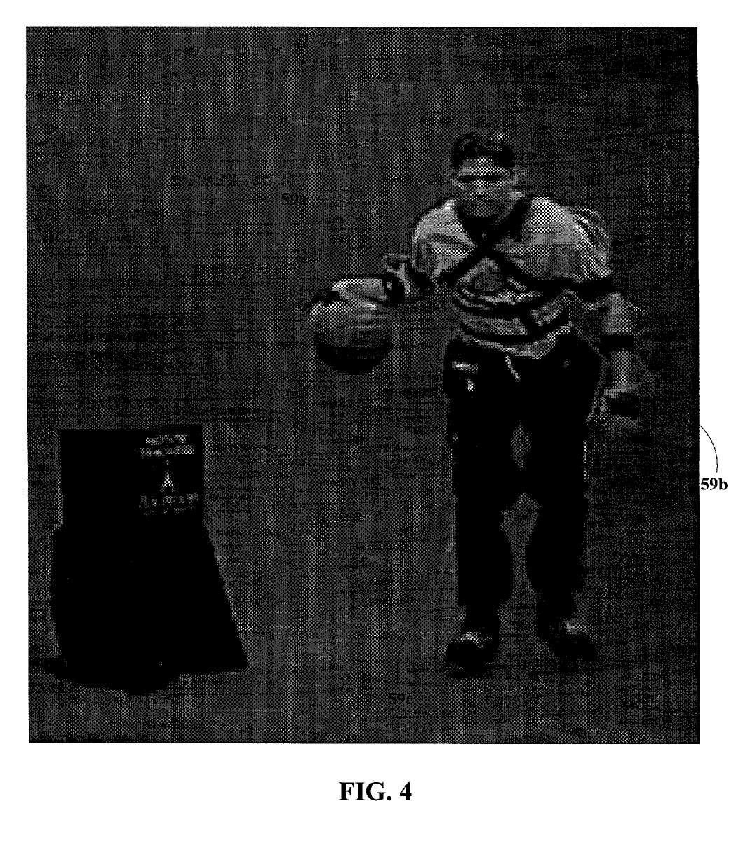

A photograph of an embodiment of an electromagnetic motion capture system is presented in FIG. 4. A human actor is outfitted with a sensor comprising a plurality of electromagnetic coils. These coils are strategically placed along moving area of the body, for example, the forearm 59a, the hand 59b, and the foot 59c, in addition to other areas. An electromagnet 59 is placed beside the target of the motion capture session. As described herein in greater detail, the actor outfitted with electromagnetic sensors 59a through 59c and performs a series of motions in from of the electromagnet 59, which are captured and used to manipulate a model on a client device according to the stored motion data.

The positional data calculator 44 receives raw position data recorded by the position data generator 24 or otherwise generated by the producer. The positional calculator 44 uses the raw position data 24 to calculate the orientation and motion of the actor with respect to the camera. The client 34 uses this data to manipulate the model data over a period of time on the client's display device 26.

The model data and calculated motion data arc transmitted by the server 36 to any client 34 requesting the data. The client 34 has memory device(s) for storing any models 48 concurrently or previously downloaded from the server 36 and for storing the motion data 52. The client contains a video renderer and texture mapper 54, which may be comprised of hardware and/or software elements, which renders the manipulation of the model data at a dynamically or predefined location on the display device. The video renderer and texture mapper use the motion data to manipulate the orientation and motion of the model data. For example, a model of a man could be made to run, jump, or dance according to the motion instructions generated by a person whose motion was captured by the positional data generator 24. The resulting rendered video and any accompanying audio or other associated and synchronized media assets are presented on a display 26 attached to the client 34.

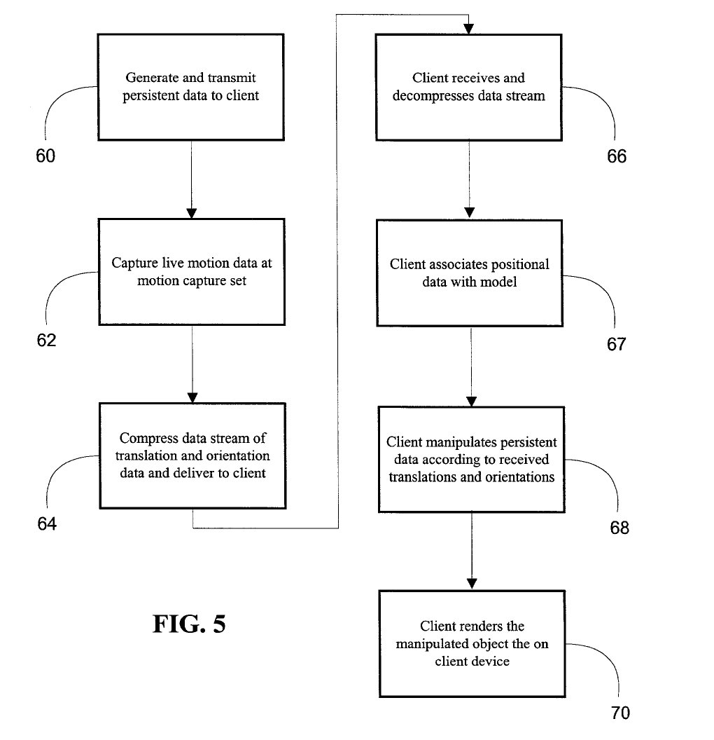

One embodiment of a process using the system of FIG. 1 is shown in FIG. 5. Producers generate and transmit persistent data to clients, step 60. Persistent data is comprises that part of the data stream that remains static from frame to frame such as the shape and geometry of the object including skeletal geometry in the form of 3D models, the texture maps, and formula needed to translate forthcoming transient data. This model data is either captured through the digitization of an actor or generated through the use 3D modeling software. The completed models and associated data are preferably transmitted to the client in advance of the motion data so as to minimize the bandwidth required to display the motion data.

The motion of an actor over time is captured and stored on a storage device, step 62. Motion data is regarded as transient data because it useful or relevant for fairly short periods of time, once the moment in time associated with a subsection of the total motion data has passed it is useless to the remainder of the presentation. In the case of a human actor, this transient data consists of e.g., the angles of each joint or the displacement of the hip in space and their motion over a period of time. As will be explained in greater detail herein, exemplary systems for capturing motion data include infrared tracking systems and electromagnetic tracking systems. The raw captured positional data is combined and transformed by a positional data calculator to track the actor's motion in 3D space.

The calculated motion data is passed to a motion compressor, which compresses the data into a stream of translation and orientation data, and transmits it to requesting clients, step 64. The use of compression allows the invention to further limit the bandwidth required to reproduce full motion of the model on the client. When compressing motion data captured from a human actor, for example, the offset of the hip may be compressed to a 16-bit number. Similarly, orientation of the hip and each of the joints may be compressed to a 45-bit number. This exemplary compression gives a very high fidelity to the original data while being compressed to a very small bandwidth. The requesting client receives the compressed data and decompresses it, step 66.

The received motion data is associated with a model stored on the client's model storage device, step 67. The selected model is manipulated over time according to the translation and orientations instructions contained within the motion data, step 68. As the model is manipulated for each frame of video, the client's video renderer and texture mapper renders the manipulated object on the display device, step 70. In this manner, the model of the actor will be manipulated over a period of time in accordance with the motion data captured from the motion of the actor, thereby recreating the video as originally recorded.

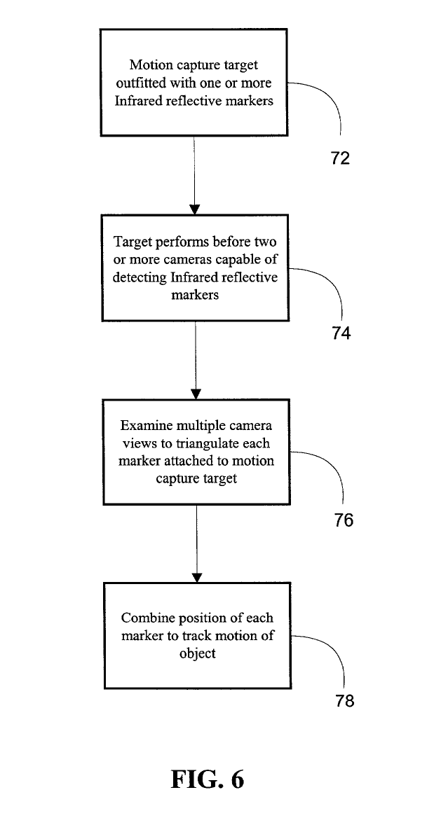

FIG. 6 presents an embodiment of the process for capturing live motion data through the use of infrared reflective markers. A target of the motion capture session is outfitted with a plurality of infrared reflective markers, preferably distributed across the actor so as to fully capture the actor's total motion, step 72. The target performs before two or more cameras capable of detecting the infrared reflective markers, step 74. By detecting or otherwise tracking the infrared reflective markers, each camera is able to record the position of every marker in 2D space. This is the raw motion data. A positional data calculator analyzes the data recorded by the plurality of cameras to triangulate the position of each marker in 3D space, step 76, thereby allowing the system to follow the motion of each marker as the actor moves or performs. The position of all the markers in 3D space over the total recoding time are synchronized to create a mathematical representation of the motion of the actor during the motion capture session, step 78.

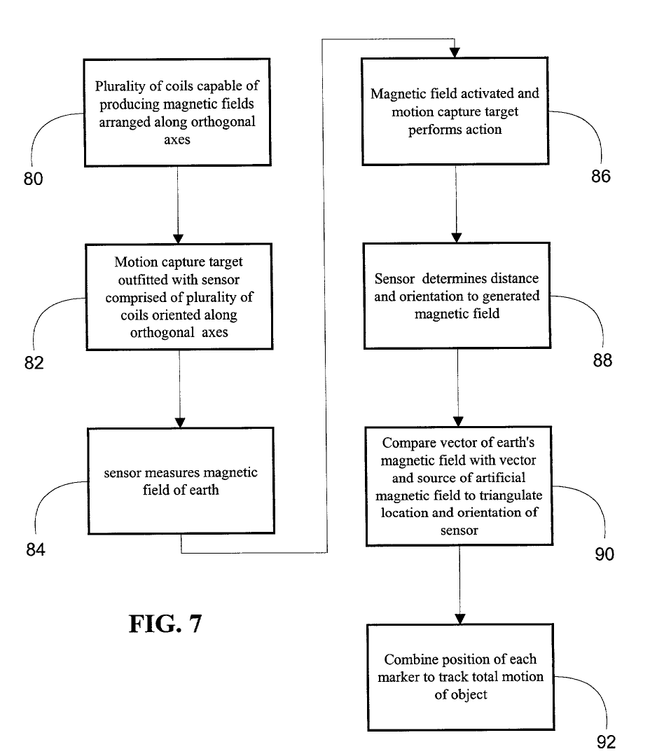

FIG. 7 presents an alternative embodiment of the process for capturing live motion data utilizing coils and electromagnetic sensors. A plurality of coils capable of producing magnetic fields are arranged along orthogonal axes, step 80. The location of each coil is fixed and recorded. The motion capture target is outfitted with a magnetic sensor comprised of a plurality of coils or markers oriented along orthogonal axes, step 82. While the coils are not generating a magnetic field, the sensor measures the magnetic field of the earth, step 84. The magnetic fields are rapidly activated and deactivated as the motion capture target performs, step 86. As the actor performs, the sensor continually measures the distance and orientation between its coils and the coils generating the artificial magnetic field, step 88. The collected data for each magnetic marker is passed to the positional data calculator where the vector of the earth's magnetic field is compared with the vector of the source of the magnetic field to triangulate the locations of the sensor in 3D space, step 90, thereby allowing the system to follow the motion of each marker as the actor moves or performs. The position of all the markers in 3D space over the total recoding time are synchronized to create a mathematical representation of the motion of the actor during the motion capture session, step 92.

In some embodiments, the system of the present invention is utilized with a media engine such as described in the commonly owned, above referenced patent applications. Using the media engine and related tools, the producer determines a show to be produced, selects talent, and uses modeling or authoring tools to create a 3D version of a real set. This and related information is used by the producer to create a show graph. The show graph identifies the replaceable parts of the resources needed by the client to present the show, resources being identified by unique identifiers, thus allowing a producer to substitute new resources without altering the show graph itself. The placement of taps within the show graph define the bifurcation between the server and client as well as the bandwidth of the data transmissions.

The show graph allows the producer to define and select elements wanted for a show and arrange them as resource elements. These elements are added to a menu of choices in the show graph. The producer starts with a blank palette, identifies generators, renderers and filters such as from a producer pre-defined list, and lays them out and connects them so as to define the flow of data between them. The producer considers the bandwidth needed for each portion and places taps between them. A set of taps is laid out for each set of client parameters needed to do the broadcast. The show graph's layout determines what resources are available to the client, and how the server and client share filtering and rendering resources. In this system, the performance of the video distribution described herein is improved by more optimal assignment of resources.

While the invention has been described and illustrated in connection with preferred embodiments, many variations and modifications as will be evident to those skilled in this art may be made without departing, from the spirit and scope of the invention, and the invention is thus not to be limited to the precise details of methodology or construction set forth above as such variations and modification are intended to be included within the scope of the invention.

What is claimed is:

1. A method for distributing motion data over a network to a client device, the method comprising:
storing model data representing an actor;
capturing motion data representing a position and attitude of the actor at a first time and a second time;
transmitting from a server to the client device as separate data items the model data and motion data to thereby enable the client device to reproduce the actor's motion as captured.

2. The method of claim 1, comprising transmitting the model data in advance of the motion data.

3. The method of claim 2, comprising the client device persistently storing the transmitted model data for use with a plurality of motion data items.

4. The method of claim 1, wherein capturing motion data is achieved through the use of a marker placed on the actor.

5. The method of claim 4, wherein capturing motion data comprises marking the actor with an infrared reflective marker.

6. The method of claim 5, wherein capturing motion data comprises marking the actor with a plurality of infrared reflective markers.

7. The method of claim 4, comprising tracking the markers to capture motion data comprising a position and attitude of the actor at a first time and a second time.

8. The method of claim 4, wherein capturing motion data comprises marking the actor with an electromagnetic marker.

9. The method of claim 8, wherein capturing motion data comprises marking the actor with a plurality of electromagnetic markers.

10. A method for receiving motion data over a network and presenting it on a client device, the method comprising:
receiving from a server as separate data items model data representing skeletal geometry and texture of an actor and motion data representing the position and attitude of an actor at a first time and a second time;
manipulating the model data according to the motion data to thereby reproduce the motion of the actor; and
presenting the manipulated model on a client device.

11. The method of claim 10, wherein the model data comprises graphical data representing an actor.

12. The method of claim 11, wherein the graphical data is configured to be presented as a three-dimensional image.

14. A method for distributing motion data over a network, the motion data representing an actor in motion, the method comprising:
generating a model of an actor comprising the skeletal geometry and texture of the actor and motion data representing the position and attitude of an actor at a first time and a second time;
transmitting from a server to the client as separate data items the model and motion data;
the client receiving the model and motion data;
the client determining based upon the motion data how to manipulate the model; and
the client presenting the manipulated model.

15. A system for preparing motion data for distribution over a network to one or more clients, the motion data containing the motion of one or more actors, the system comprising:
a positional data capturing system for capturing motion data representing a position and attitude of the actor at a first time and a second time;
a model storage system for storing models of the actors, the models comprising the skeletal geometry and texture of the actors; and
a transmission system for transmitting the model in association with corresponding motion data for presentation by one or more clients.

16. The system of claim 15, wherein a compression system is used to reduce the size of the motion data.

17. The system of claim 15, wherein the positional data capturing system comprises using infrared reflective markers to track an actor's motion.

18. The system of claim 15, wherein the positional data capturing system comprises using electromagnetic markers to track an actor's motion.
